(19) United States
(12) Patent Application Publication
(10) Pub. No.: US 2019/0002780 A1
(43) Pub. Date: Jan. 3, 2019

(54) DETERGENT ADDITIVE FOR FUEL

(71) Applicant: TOTAL MARKETING SERVICES, Puteaux (FR)

(72) Inventor: Julie PREVOST, Lyon (FR)

(73) Assignee: TOTAL MARKETING SERVICES, Puteaux (FR)

(21) Appl. No.: 16/065,252

(22) PCT Filed: Dec. 19, 2016
(86) PCT No.: PCT/FR2016/053556

§ 371 Date: Jun. 22, 2018

(30) Foreign Application Priority Data
Dec. 22, 2015 (FR) 1563098

(51) Int. Cl. C10L 1/236; C10L 10/18; C10L 10/04; C10L 10/02; C10L 10/06; F02M 65/00; F02B 77/04

(52) U.S. Cl. CPC C10L 1/2362; C10L 10/18; C10L 10/04; C10L 10/02; C10L 10/06; F02M 65/007; C10L 2270/026; C10L 2230/22; C10L 2250/04; C10L 2200/0423; C10L 2200/0446; C10L 2270/023; F02B 77/04

(57) ABSTRACT

The use of one or more copolymers as a detergent additive in a liquid fuel for internal combustion engines. The copolymer includes at least one repeat unit having an ester of alkyl or alkyl ester function and a repeat unit containing a nitrile group.

The present invention relates to the use of copolymers based on monomers comprising an ester function, for instance (meth)acrylates or olefinic alkylesters, and on monomers comprising a nitrile function, as detergent additives in a liquid fuel for an internal combustion engine.

### PRIOR ART

Liquid fuels for internal combustion engines contain components that can degrade during the functioning of the engine. The problem of deposits in the internal parts of combustion engines is well known to motorists. It has been shown that the formation of these deposits has consequences on the performance of the engine and in particular has a negative impact on consumption and particle emissions. Progress in the technology of fuel additives has made it possible to confront this problem. “Detergent” additives used in fuels have already been proposed to keep the engine clean by limiting deposits (“keep-clean” effect) or by reducing the deposits already present in the internal parts of the combustion engine (“clean-up” effect). Mention may be made, for example, of U.S. Pat. No. 4,171,959 which describes a detergent additive for gasoline fuel containing a quaternary ammonium function. WO 2006/135 881 describes a detergent additive containing a quaternary ammonium salt used for reducing or cleaning deposits, especially on the intake valves.

FR 1 390 228 describes copolymers that may be used as dispersants in lubricant oils and in fuels. These copolymers are based on the copolymerization of ethyl acrylate or of methyl acrylate with one or two other monomers of long-chain alkyl acrylate type to give them solubility in oils and also optional additional comonomers.

FR 1 359 939 describes copolymers that may be used as dispersants in lubricant compositions and in hydrocarbon-based fuels. These copolymers are constituted of vinyl ester units of C1 to C3 carboxylic acids, borne by a polymer chain based on long-chain acrylic esters and optionally comonomers.

U.S. Pat. No. 3,067,163 describes grafted copolymers with dispersing properties, which may be used in oils. These copolymers are obtained by polymerizing, in a first stage, an oil-soluble vinyl monomer, optionally in the presence of a second monomer. Next, a vinyl monomer bearing a nitrogenous function comprising at least two substituents is grafted onto the base polymer.

However, engine technology is in constant evolution and the stipulations for fuels must evolve to cope with these technological advances of combustion engines. In particular, the novel gasoline or diesel direct-injection systems expose the injectors to increasingly severe pressure and temperature conditions, which promotes the formation of deposits. In addition, these novel injection systems have more complex geometries to optimize the spraying, in particular more numerous holes having smaller diameters, but which, on the other hand, induce greater sensitivity to deposits. The presence of deposits may impair the combustion performance and in particular increase pollutant emissions and particle emissions. Other consequences of the excessive presence of deposits have been reported in the literature, such as the increase in fuel consumption and maneuverability problems.

Preventing and reducing deposits in these novel engines are essential for optimum functioning of modern engines. There is thus a need to propose detergent additives for fuel which promote optimum functioning of combustion engines, especially for novel engine technologies.

There is also a need for a universal detergent additive that is capable of acting on deposits irrespective of the technology of the engine and/or the nature of the fuel.

### SUBJECT OF THE INVENTION

The invention relates to the use of copolymers comprising an ester function, for instance (meth)acrylates or olefinic alkylesters, especially vinyl esters, and on monomers functionalized with a nitrile function as detergent additives in a liquid fuel for an internal combustion engine. These copolymers may be used in the form of an additive concentrate.

The Applicant has discovered that certain families of copolymers, including the copolymers of the invention, have noteworthy properties as detergent additives in liquid fuels for internal combustion engines. The copolymers according to the invention used in these fuels can keep the engine clean, in particular by preventing or limiting the formation of deposits (“keep-clean” effect) and/or by reducing the deposits already present in the internal parts of the combustion engine (“clean-up” effect).

The advantages associated with the use according to the invention of such copolymers are:
optimum functioning of the engine,
reduction of the fuel consumption,
better maneuverability of the vehicle,
reduced pollutant emissions, and
savings due to less engine maintenance.

The subject of the present invention consequently relates to the use of a copolymer as detergent additive in a liquid fuel for an internal combustion engine, said copolymer comprising at least one repeating unit comprising an alkyl ester or alkylester function and one repeating unit comprising a nitrile group.

According to a preferred embodiment, the copolymer is a block copolymer comprising at least:
one block A consisting of a chain of structural units derived from an alkyl (meth)acrylate monomer (mₐ), and
one block B consisting of a chain of structural units derived from an olefinic monomer (m_{b}) comprising a nitrile group.

According to a more preferred embodiment, the block copolymer is obtained by block polymerization, preferably by controlled block polymerization, optionally followed by one or more post-functionalizations.

According to a preferred embodiment, the copolymer is obtained by copolymerization of at least:
one alkyl (meth)acrylate monomer (mₐ), and
one olefinic monomer (m_{b}) comprising a nitrile group.

According to a preferred embodiment, the alkyl (meth)acrylate monomer (mₐ) is chosen from C₁ to C₃₄ alkyl (meth)acrylates.

According to a preferred embodiment, the monomer (m_{b}), comprising at least one nitrile group, corresponds to formula (I) below:

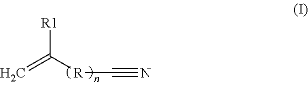

in which

n represents an integer chosen from 0 and 1,

R represents a hydrocarbon-based chain comprising from 1 to 24 carbon atoms, optionally comprising one or more substituents chosen from: OH, NH2, CN and/or optionally comprising one or more groups chosen from: an ether bridge —O—, an amine bridge —NH—, an imine bridge —N═, an ester bridge —COO—, a ketone bridge —CO—, an amide bridge —CONH—, a urea bridge —NH—CO—NH—, a carbamate bridge —O—CO—NH—.

R₁ represents H or CH3.

According to a more preferred embodiment, the monomer (m_{b}) is chosen from acrylonitrile, methacrylonitrile, cyanostyrene and cyano-alpha-methylstyrene, preferably from acrylonitrile and methacrylonitrile.

According to an even more advantageous embodiment, the copolymer is a block copolymer comprising at least:
one block A consisting of a chain of structural units derived from the alkyl (meth)acrylate monomer (mₐ), and
one block B₁ consisting of a chain of structural units derived from acrylonitrile (m_{b}), methacrylonitrile, cyanostyrene or cyano-alpha-methylstyrene, preferably from acrylonitrile or methacrylonitrile.

According to a preferred embodiment, the copolymer is used in a concentrate for fuel comprising one or more copolymers as described above, as a mixture with an organic liquid, said organic liquid being inert with respect to the copolymer(s) and miscible with said fuel.

According to a preferred embodiment, the invention is used in a fuel composition which comprises:

(1) the liquid fuel for an internal combustion engine and

(2) one or more copolymers as described above, said fuel (1) being derived from one or more sources chosen from the group consisting of mineral, animal, plant and synthetic sources

According to a more preferred embodiment, the fuel composition comprises at least 5 ppm of at least one copolymer as defined above.

According to a preferred embodiment, the fuel is chosen from hydrocarbon-based fuels and fuels that are not essentially hydrocarbon-based, alone or as a mixture.

According to a preferred embodiment, the copolymer is used in the liquid fuel to keep clean and/or to clean up at least one of the internal parts of said internal combustion engine.

According to a preferred embodiment, the copolymer is used in the liquid fuel to avoid and/or reduce the formation of deposits in at least one of the internal parts of said engine and/or to reduce the existing deposits in at least one of the internal parts of said engine.

According to a preferred embodiment, the copolymer is used to reduce the fuel consumption of an internal combustion engine.

According to a preferred embodiment, the copolymer is used to limit and/or reduce and/or avoid and/or prevent pollutant emissions, in particular the particle emissions of an internal combustion engine.

According to a preferred embodiment, the internal combustion engine is a spark ignition engine.

According to a preferred embodiment, the copolymer is used to limit and/or reduce and/or prevent the formation of deposits in at least one internal part of a spark ignition engine chosen from the engine intake system, in particular the intake valves, the combustion chamber, the fuel injection system, in particular the injectors of an indirect injection system or the injectors of a direct injection system.

According to a preferred embodiment, the internal combustion engine is a diesel engine.

According to a preferred embodiment, the copolymer is used to limit and/or reduce and/or avoid and/or prevent the formation of deposits in the injection system of a diesel engine, preferably on an external part of an injector of said injection system, for example the fuel spray tip, and/or on an internal part of an injector of said injection system, for example on the surface of an injector needle.

According to a more preferred embodiment, the copolymer is used to limit and/or reduce and/or avoid and/or prevent the formation of deposits associated with coking and/or deposits of soap and/or lacquering type.

According to an even more advantageous embodiment, the copolymer is used to limit and/or reduce and/or avoid and/or prevent power loss due to the formation of said deposits in the internal parts of a direct-injection diesel engine, said power loss being determined according to the standardized engine test method CEC F-98-08.

According to an even more advantageous embodiment, the copolymer is used to limit and/or reduce and/or avoid and/or prevent restriction of the fuel flow emitted by the injector of a direct-injection diesel engine during its functioning, said flow restriction being determined according to the standardized engine test method CEC F-23-1-01.

### DETAILED DESCRIPTION

Other advantages and characteristics will emerge more clearly from the description that follows. The particular embodiments of the invention are given as nonlimiting examples.

According to the invention, the copolymer comprises at least one repeating unit comprising an alkyl ester or alkylester function and one repeating unit comprising at least one nitrile group.

The term “alkyl ester” denotes an alkyl carboxylate A₁-Co—O-A₂ with A₂ an alkyl and A₁ any group.

The term “alkylester” denotes an alkylcarboxylate A₁-CO—O-A₂ with A₁ an alkyl and A₂ any group.

Advantageously, the repeating unit comprising an alkyl ester or alkylester function is an olefinic unit.

Advantageously, the repeating unit comprising at least nitrile group is an olefinic unit.

For example, the repeating unit comprising an alkyl ester function may be derived from an alkyl acrylate or alkyl methacrylate monomer. For example, the repeating unit comprising an alkylester function may be derived from a vinyl alkylester or 2-propenyl alkylester monomer.

Preferably, the repeating unit comprising an alkyl ester function is derived from at least one monomer chosen from alkyl acrylate and alkyl methacrylate monomers (mₐ).

For reasons of simplicity, in the rest of the description, the term “alkyl (meth)acrylate” denotes a monomer chosen from alkyl acrylates and alkyl methacrylates.

The monomer (mₐ) is preferably chosen from C₁ to C₃₄, preferably C₄ to C₃₀, more preferentially C₆ to C₂₄ and even more preferentially C₈ to C₂₂ alkyl (meth)acrylates. The alkyl radical of the alkyl acrylate or methacrylate is linear, branched, cyclic or acyclic, preferably acyclic.

Among the alkyl (meth)acrylates that may be used in the manufacture of the copolymer of the invention, mention may be made, in a nonlimiting manner, of: n-octyl acrylate, n-octyl methacrylate, n-decyl acrylate, n-decyl methacrylate, n-dodecyl acrylate, n-dodecyl methacrylate, 2-ethylhexyl acrylate, 2-ethylhexyl methacrylate, isooctyl acrylate, isooctyl methacrylate, isodecyl acrylate, isodecyl methacrylate.

The vinyl alkylester monomers correspond to the formula R′CO—O—CH═CH₂, in which R′ represents a linear, branched, cyclic or acyclic, preferably acyclic, alkyl group. Preferably, R′ is a linear C₁ to C₃₄, preferably C₄ to C₃₀, more preferentially C₆ to C₂₄ and even more preferentially C₈ to C₂₂ alkyl.

Among the vinyl alkylester monomers, examples that may be mentioned include vinyl octanoate, vinyl decanoate, vinyl dodecanoate, vinyl tetradecanoate, vinyl hexadecanoate, vinyl octadecanoate and vinyl docosanoate.

Preferably, the repeating unit comprising a nitrile group is derived from at least one olefinic monomer (m_{b}) comprising at least one nitrile group.

Preferably, the olefinic monomer (m_{b}) comprising at least one nitrile group corresponds to formula (I) below:

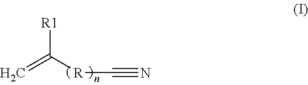

in which:

n represents an integer chosen from 0 and 1,

R represents a linear, branched or cyclic, saturated or unsaturated hydrocarbon-based chain, comprising from 1 to 24 carbon atoms, optionally comprising one or more substituents chosen from: OH, NH2, CN and/or optionally comprising one or more groups chosen from: an ether bridge —O—, an amine bridge —NH—, an imine bridge —N═, an ester bridge —COO—, a ketone bridge —CO—, an amide bridge —CONH—, a urea bridge —NH—CO—NH—, a carbamate bridge —O—CO—NH—, R1 represents H or CH3.

The term “hydrocarbon-based chain” means a chain constituted exclusively of carbon and hydrogen atoms, said chain possibly being linear or branched, cyclic, polycyclic or acyclic, saturated or unsaturated, and optionally aromatic or polyaromatic. A hydrocarbon-based chain may comprise a linear or branched part and a cyclic part. It may comprise an aliphatic part and an aromatic part. The definition of R also includes saturated or unsaturated heterocyclic groups, comprising an alkyl part and at least one ether bridge —O— or one amine bridge —NH—, one imine bridge —N═, one ester bridge —COO—, one ketone bridge —CO—, one amide bridge —CONH—, one urea bridge —NH—CO—NH— or one carbamate bridge —O—CO—NH—.

Preferably, R is chosen from linear or branched C1-C6 alkyl chains.

According to a preferred embodiment of the invention, n represents 0 and the compound of formula (I) is acrylonitrile: CH2=CH—CN or methacrylonitrile CH2=C(CH3)-CN.

According to another preferred embodiment, R is chosen from C1-C10 aromatic rings optionally substituted with one or more substituents chosen from: OH, NH2, CN.

According to a preferred variant of this embodiment, n represents 1, R is a phenyl group and the compound of formula (I) is cyanostyrene, the nitrile group being in the ortho, meta or para position, preferably in the para position.

The copolymer may be prepared according to any known polymerization process. The various polymerization techniques and conditions are widely described in the literature and fall within the general knowledge of a person skilled in the art.

It is understood that it would not constitute a departure from the scope of the invention if the copolymer according to the invention were obtained from monomers other than (mₐ) and (m_{b}), provided that the final copolymer corresponds to that of the invention, i.e. a polymer obtained by copolymerization of at least (mₐ) and (m_{b}). For example, it would not constitute a departure from the scope of the invention if the copolymer were obtained by copolymerization of monomers other than (mₐ) and (m_{b}) followed by post-functionalization.

For example, the units derived from an alkyl (meth)acrylate monomer (mₐ) may be obtained from a polymethyl (meth)acrylate fragment, by transesterification reaction using an alcohol of chosen chain length to form the expected alkyl group.

For example, the repeating unit comprising a nitrile group (m_{b}) may be obtained from a polyvinyl fragment functionalized with a precursor group of the nitrile group, such as for example, an aldehyde or a carboxylic acid. Such conversion reactions are well known to those skilled in the art.

The copolymer may be a statistical copolymer or a block copolymer.

Preferably, the copolymer is a block copolymer comprising at least:
one block A consisting of a chain of repeating units comprising an alkyl ester function, and
one block B consisting of a chain of repeating units comprising at least one nitrile group.

Preferably, the copolymer is a block copolymer comprising at least:
one block A consisting of a chain of structural units derived from the monomer (mₐ), and
one block B consisting of a chain of structural units derived from the monomer (m_{b}).

According to a particular embodiment, the block copolymer is obtained by copolymerization of at least the alkyl (meth)acrylate monomer (mₐ) and of at least the monomer having a nitrile function (m_{b}).

The block copolymer may be obtained by block polymerization, preferably by controlled block polymerization, optionally followed by one or more post-functionalizations.

According to a particular embodiment, the block copolymer described above is obtained by controlled block polymerization. The polymerization is advantageously chosen from controlled radical polymerization; for example atom transfer radical polymerization (ATRP); nitroxide-mediated radical polymerization (NMP); degenerative transfer processes such as degenerative iodine transfer polymerization (ITRP) or reversible addition-fragmentation chain transfer radical polymerization (RAFT); polymerizations derived from ATRP such as polymerizations using initiators for continuous activator regeneration (ICAR) or using activators regenerated by electron transfer (ARGET).

Mention will be made, by way of example, of the publication “Macromolecular engineering by atom transfer radical polymerization” JACS, 136, 6513-6533 (2014), which describes a controlled block polymerization process for forming block copolymers.

The controlled block polymerization is typically performed in a solvent, under an inert atmosphere, at a reaction temperature generally ranging from 0 to 200° C., preferably from 50° C. to 130° C. The solvent may be chosen from polar solvents, in particular ethers such as anisole (methoxybenzene) or tetrahydrofuran, or apolar solvents, in particular paraffins, cycloparaffins, aromatic and alkylaromatic solvents containing from 1 to 19 carbon atoms, for example benzene, toluene, cyclohexane, methylcyclohexane, n-butene, n-hexane, n-heptane and the like.

For atom-transfer radical polymerization (ATRP), the reaction is generally performed under vacuum in the presence of an initiator, a ligand and a catalyst. As examples of ligands, mention may be made of N,N,N′,N″,N″-pentamethyldiethylenetriamine (PMDETA), 1,1,4,7,10,10-hexamethyltriethylenetetramine (HMTETA), 2,2′-bipyridine (BPY) and tris(2-pyridylmethyl)amine (TPMA). Examples of catalysts that may be mentioned include: CuX, CuX₂, with X═Cl, Br and the ruthenium-based complexes Ru²⁺/Ru³⁺.

The ATRP polymerization is preferably performed in a solvent chosen from polar solvents.

According to the controlled block polymerization technique, it may also be envisaged to work under pressure.

According to a particular embodiment, the number of equivalents of monomer (mₐ) in block A and of monomer (m_{b}) in block B reacted during the polymerization reaction are identical or different and independently range from 2 to 40, preferably from 3 to 30, more preferentially from 4 to 20 and even more preferentially from 5 to 10. The term “number of equivalents” means the ratio between the amounts (in moles) of material of the monomers (mₐ) of block A and of the monomers (m_{b}) of block B, used during the polymerization reaction.

The number of equivalents of monomer (mₐ) in block A is advantageously greater than or equal to the number of equivalents of the monomer (m_{b}) in block B. In addition, the weight-average molar mass M_{w} of block A or of block B is preferably less than or equal to 15 000 g.mol.⁻¹, more preferentially less than or equal to 10 000 g.mol.⁻¹.

The block copolymer advantageously comprises at least one sequence of blocks AB, ABA or BAB in which said blocks A and B form a chain without the presence of an intermediate block of different chemical nature.

Other blocks may optionally be present in the block copolymer described previously provided that these blocks do not fundamentally change the nature of the block copolymer. Block copolymers solely containing blocks A and B will, nevertheless, be preferred.

Preferably, the blocks A and B represent at least 70% by mass of the total mass of monomers used in the polymerization reaction, preferably at least 90% by mass, advantageously at least 95% by mass and better still at least 99% by mass.

According to a particular embodiment, the block copolymer is a diblock copolymer.

According to another particular embodiment, the block copolymer is a triblock copolymer with alternating blocks comprising two blocks A and one block B (ABA) or comprising two blocks B and one block A (BAB).

According to a particular embodiment, the block copolymer also comprises an end chain I consisting of a saturated or unsaturated, linear, branched or cyclic C₁ to C₃₂, preferably C₄ to C₂₄, and more preferentially C₁₀ to C₂₄ hydrocarbon-based chain.

The term “cyclic hydrocarbon-based chain” means a hydrocarbon-based chain of which at least part is cyclic, especially aromatic. This definition does not exclude hydrocarbon-based chains comprising both an acyclic part and a cyclic part.

The end chain I may comprise an aromatic hydrocarbon-based chain, for example benzene-based, and/or a saturated and acyclic, linear or branched hydrocarbon-based chain, in particular an alkyl chain.

The end chain I is preferably chosen from alkyl chains, which are preferably linear, more preferentially alkyl chains of at least 4 carbon atoms and even more preferentially of at least 12 carbon atoms.

For the ATRP polymerization, the end chain I is located in the end position of the block copolymer. It may be introduced into the block copolymer by means of the polymerization initiator. Thus, the end chain I may advantageously constitute at least part of the polymerization initiator and is positioned in the polymerization initiator so as to allow the introduction, during the first step of polymerization initiation, of the end chain I in the end position of the block copolymer.

The polymerization initiator is chosen, for example, from the free-radical initiators used in the ATRP polymerization process. These free-radical initiators well known to those skilled in the art are described especially in the article “Atom-transfer radical polymerization: current status and future perspectives, Macromolecules, 45, 4015-4039, 2012”.

The polymerization initiator is chosen, for example, from alkyl esters of a carboxylic acid substituted with a halide, preferably a bromine in the alpha position, for example ethyl 2-bromopropionate, ethyl a-bromoisobutyrate, benzyl chloride or bromide, ethyl α-bromophenylacetate and chloroethylbenzene. Thus, for example, ethyl 2-bromopropionate may allow the introduction into the copolymer of the end chain I in the form of a C₂ alkyl chain and of benzyl bromide in the form of a benzyl group.

For the RAFT polymerization, the transfer agent may conventionally be removed from the copolymer at the end of polymerization according to any known process.

According to a particular embodiment, the end chain I may be obtained via the methods described in the article by Moad, G. et al., Australian Journal of Chemistry, 2012, 65, 985-1076. For example, the end chain I may be introduced by aminolysis when a transfer agent is used. Examples that may be mentioned include transfer agents of thiocarbonylthio, dithiocarbonate, xanthate, dithiocarbamate and trithiocarbonate type, for example S,S-bis(α,α′-dimethyl-α″-acetic acid) trithiocarbonate (BDMAT) or 2-cyano-2-propyl benzodithioate.

According to a particular embodiment, the block copolymer is a diblock copolymer. The block copolymer structure may be of the IAB or IBA type, advantageously of the IAB type. The end chain I may be connected directly to block A or B as the structure IAB or IBA, respectively, or may be connected via a bonding group, for example an ester, amide, amine or ether function. The bonding group then forms a bridge between the end chain I and block A or B.

According to a particular embodiment, the block copolymer may also be functionalized at the chain end according to any known process, especially by hydrolysis, aminolysis and/or nucleophilic substitution.

The term “aminolysis” means any chemical reaction in which a molecule is split into two parts by reaction of an ammonia molecule or an amine. A general example of aminolysis consists in replacing a halogen of an alkyl group by reaction with an amine, with removal of hydrogen halide. Aminolysis may be used, for example, for an ATRP polymerization which produces a copolymer bearing a halide in the end position or for a RAFT polymerization to remove the thio, dithio or trithio bond introduced into the copolymer by the RAFT transfer agent.

It is thus possible to introduce an end chain I′ by post-functionalization of the block copolymer obtained by controlled block polymerization of the monomers mₐ and m_{b} described above.

The end chain I′ advantageously comprises a linear, branched or cyclic C₁ to C₃₂, preferably C₁ to C₂₄ and more preferentially C₁ to C₁₀ hydrocarbon-based chain, even more preferentially an alkyl group, optionally substituted with one or more groups containing at least one heteroatom chosen from N and 0, preferably N.

For an ATRP polymerization using a metal halide as catalyst, this functionalization may be performed, for example, by treating the copolymer IAB or IBA obtained by ATRP with a primary C₁ to C₃₂ alkylamine or a C₁ to C₃₂ alcohol under mild conditions so as not to modify the functions present on the blocks A, B and I.

According to a preferred embodiment, the monomer m_{b} is chosen from acrylonitrile and cyanostyrene, preferably acrylonitrile.

According to a preferred embodiment, the block copolymer is as described above and block B is a block B₁ consisting of a chain of structural units derived from the acrylonitrile monomer.

The block copolymer in particular comprises at least one sequence of blocks AB₁, AB₁A or B₁AB₁ in which blocks A and B₁ form a chain without the presence of an intermediate block of different chemical nature.

The block copolymer in particular comprises at least one sequence of blocks AB₁, AB₁A or B₁AB₁ in which blocks A and B₁ form a chain without the presence of an intermediate block of different chemical nature.

According to a variant embodiment, B₁ consists of a chain bearing structural units which are derived from the cyanostyrene monomer, the nitrile group being in the ortho, meta or para position, preferably in the para position.

According to a preferred particular embodiment, the block copolymer is represented by formula (IIa) below or by formula (IIb) below:

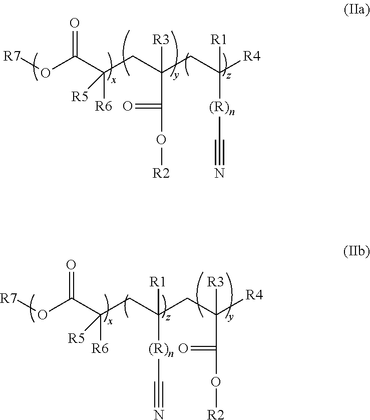

in which:
R, R₁, and n are as defined above in formula (I),
x=0 or 1,
y is an integer ranging from 2 to 40, preferably from 3 to 30, more preferentially from 4 to 20, even more preferentially from 5 to 10,
z is an integer ranging from 2 to 40, preferably from 3 to 30, more preferentially from 4 to 20, even more preferentially from 5 to 10,
R₂ is chosen from linear, branched or cyclic, preferably acyclic, C₁ to C₃₄, preferably C₄ to C₃₀, more preferentially C₆ to C₂₄ and even more preferentially C₈ to C₂₂ alkyl groups,
R₃ is chosen from hydrogen and a methyl group,
R₄ is chosen from the group constituted by:
   hydrogen;
   OH;
   halogens, preferably bromine; and
   linear, branched or cyclic, saturated or unsaturated C₁ to C₃₂, preferably C₁ to C₂₄ and more preferentially C₁ to C₁₀ hydrocarbon-based chains, preferably alkyl groups, said hydrocarbon-based chains being optionally substituted with one or more groups containing at least one heteroatom chosen from N and O,
R₅ and R₆ are identical or different and chosen independently from the group constituted by hydrogen and linear or branched C₁ to C₁₀ and preferably C₁ to C₄ alkyl groups, even more preferentially a methyl group,
R₇ is chosen from hydrocarbon-based chains, preferably cyclic or acyclic, saturated or unsaturated, linear or branched C₁ to C₃₂, preferably C₄ to C₂₄ and more preferentially C₁₀ to C₂₄ alkyl groups, and groups derived from a reversible addition-fragmentation chain-transfer (RAFT) radical polymerization transfer agent, it being understood that if R₇ is a group derived from a transfer agent, then x=0.

Transfer agents of RAFT type are well known to those skilled in the art. A wide diversity of RAFT-type transfer agents are available or are quite readily synthesizable. Examples that may be mentioned include transfer agents of thiocarbonylthio, dithiocarbonate, xanthate, dithiocarbamate and trithiocarbonate type, for example S,S-bis(α,α′-dimethyl-α″-acetic acid) trithiocarbonate (BDMAT) or 2-cyano-2-propyl benzodithioate.

A synthesis of block copolymer using a RAFT agent is described, for example, in the article by Zhishen Ge et al. entitled “Stimuli-Responsive Double Hydrophilic Block Copolymer Micelles with Switchable Catalytic Activity”, Macromolecules 2007, 40, 3538-3546. This article describes in particular, on pages 3540 and 3541, the synthesis of a block polymer by RAFT/MADIX polymerization. This article is cited as an example of synthesis of block copolymers and/or incorporated by reference, in particular pages 3540 and 3541.

In formulae (IIa) and (IIb), block A corresponds to the unit repeated y times and block B to the unit repeated z times. In addition, the group R₇ may be constituted of the end chain I as described above and/or the group R₄ may be constituted of the end chain I′ as described above.

The copolymer described above is particularly advantageous when it is used, alone or as a mixture, as detergent additive in a liquid fuel for an internal combustion engine.

In particular, the block copolymer described above has noteworthy properties as detergent additive in a liquid fuel for an internal combustion engine.

The term “detergent additive for a liquid fuel” means an additive which is incorporated in small amount into the liquid fuel and produces an effect on the cleanliness of said engine when compared with said liquid fuel not specially supplemented with additive.

The liquid fuel is advantageously derived from one or more sources chosen from the group consisting of mineral, animal, plant and synthetic sources. Crude oil will preferably be chosen as mineral source.

The liquid fuel is preferably chosen from hydrocarbon-based fuels and fuels that are not essentially hydrocarbon-based, alone or as a mixture.

The hydrocarbon-based fuels especially comprise middle distillates with a boiling point of between 100 and 500° C. or lighter distillates with a boiling point in the gasoline range. These distillates may be chosen, for example, from the distillates obtained by direct distillation of crude hydrocarbons, vacuum distillates, hydrotreated distillates, distillates derived from the catalytic cracking and/or hydrocracking of vacuum distillates, distillates resulting from conversion processes such as ARDS (atmospheric residue desulfurization) and/or viscoreduction, and distillates derived from the upgrading of Fischer-Tropsch fractions. The hydrocarbon-based fuels are typically gasolines and gas oils (also known as diesel fuel).

Gasolines in particular comprise any commercially available fuel composition for a gasoline engine. Representative examples that may be mentioned are the gasolines corresponding to standard NF EN 228. Gasolines generally have octane numbers that are high enough to avoid pinking. Typically, the fuels of gasoline type sold in Europe, in accordance with standard NF EN 228, have a motor octane number (MON) of greater than 85 and a research octane number (RON) of at least 95. Fuels of gasoline type generally have an RON of between 90 and 100 and an MON of between 80 and 90, the RON and MON being measured according to standard ASTM D 2699-86 or D 2700-86.

Gas oils (diesel fuels) in particular comprise any commercially available fuel composition for diesel engines. Representative examples that may be mentioned are the gas oils corresponding to standard NF EN 590.

Fuels that are not essentially hydrocarbon-based especially comprise oxygenated fuels, for example distillates resulting from BTL (biomass-to-liquid) conversion of plant and/or animal biomass, taken alone or in combination; biofuels, for example plant and/or animal oils and/or esters of plant and/or animal oils; biodiesels of animal and/or plant origin and bioethanols.

The mixtures of hydrocarbon-based fuel and of fuel that is not essentially hydrocarbon-based are typically gas oils of Bₓ type or gasolines of Eₓ type.

The term “gas oil of Bₓ type for diesel engines” means a gas oil fuel which contains x % (v/v) of plant or animal ester oils (including spent cooking oils) transformed via a chemical process known as transesterification, obtained by reacting this oil with an alcohol so as to obtain fatty acid esters (FAE). With methanol and ethanol, fatty acid methyl esters (FAME) and fatty acid ethyl esters (FAEE) are obtained, respectively. The letter “B” followed by a number indicates the percentage of FAE contained in the gas oil. Thus, a B99 contains 99% of FAE and 1% of middle distillates of fossil origin (mineral source), B20 contains 20% of FAE and 80% of middle distillates of fossil origin, etc. Gas oils of Bₒ type which do not contain any oxygen-based compounds are thus distinguished from gas oils of Bx type which contain x% (v/v) of plant oil esters or of fatty acid esters, usually methyl esters (POME or FAME). When the FAE is used alone in engines, the fuel is designated by the term B100.

The term “gasoline of Eₓ type for gasoline engines” means a gasoline fuel which contains x % (v/v) of oxygen-based compounds, generally ethanol, bioethanol and/or tert-butyl ethyl ether (TBEE).

The sulfur content of the liquid fuel is preferably less than or equal to 5000 ppm, preferably less than or equal to 500 ppm and more preferentially less than or equal to 50 ppm, or even less than or equal to 10 ppm and advantageously sulfur-free.

The copolymer described above is used as detergent additive in the liquid fuel in a content advantageously of at least 10 ppm, preferably at least 50 ppm, more preferentially in a content ranging from 10 to 5000 ppm, even more preferentially from 10 to 1000 ppm.

According to a particular embodiment, the use of a copolymer as described previously in the liquid fuel makes it possible to maintain the cleanliness of at least one of the internal parts of the internal combustion engine and/or to clean at least one of the internal parts of the internal combustion engine.

The use of the copolymer in the liquid fuel makes it possible in particular to limit or prevent the formation of deposits in at least one of the internal parts of said engine (“keep-clean” effect) and/or to reduce the existing deposits in at least one of the internal parts of said engine (“clean-up” effect).

Thus, the use of the copolymer in the liquid fuel makes it possible, when compared with liquid fuel that is not specially supplemented, to limit or prevent the formation of deposits in at least one of the internal parts of said engine or to reduce the existing deposits in at least one of the internal parts of said engine.

Advantageously, the use of the copolymer in the liquid fuel makes it possible to observe both effects simultaneously, limitation (or prevention) and reduction of deposits (“keep-clean” and “clean-up” effects).

The deposits are distinguished as a function of the type of internal combustion engine and of the location of the deposits in the internal parts of said engine.

According to a particular embodiment, the internal combustion engine is a spark ignition engine, preferably with direct injection (DISI: direct-injection spark ignition engine). The deposits targeted are located in at least one of the internal parts of said spark ignition engine. The internal part of the spark ignition engine kept clean and/or cleaned up is advantageously chosen from the engine intake system, in particular the intake valves (IVD: intake valve deposit), the combustion chamber (CCD: combustion chamber deposit, or TCD: total chamber deposit) and the fuel injection system, in particular the injectors of an indirect injection system (PFI: port fuel injector) or the injectors of a direct injection system (DISI).

According to another particular embodiment, the internal combustion engine is a diesel engine, preferably a direct-injection diesel engine, in particular a diesel engine with a common-rail injection system (CRDI: common-rail direct injection). The deposits targeted are located in at least one of the internal parts of said diesel engine.

Advantageously, the deposits targeted are located in the injection system of the diesel engine, preferably located on an external part of an injector of said injection system, for example the fuel spray tip and/or on an internal part of an injector of said injection system (IDID: internal diesel injector deposits), for example on the surface of an injector needle.

The deposits may be constituted of coking-related deposits and/or deposits of soap and/or lacquering type.

The copolymer as described previously may advantageously be used in the liquid fuel to reduce and/or prevent and/or avoid power loss due to the formation of deposits in the internal parts of a direct-injection diesel engine, said power loss being determined according to the standardized engine test method CEC F-98-08.

The copolymer as described previously may advantageously be used in the liquid fuel to reduce and/or prevent and/or avoid restriction of the fuel flow emitted by the injector of a direct-injection diesel engine during its functioning, said flow restriction being determined according to the standardized engine test method CEC F-23-1-01.

The use of the copolymer as described above advantageously makes it possible to limit or prevent the formation of deposits in at least one of the internal parts of said engine or to reduce the existing deposits in at least one of the internal parts of said engine, on at least one type of deposit described previously.

According to a particular embodiment, the use of the copolymer described above also makes it possible to reduce the fuel consumption of an internal combustion engine.

According to another particular embodiment, the use of the copolymer described above also makes it possible to reduce the pollutant emissions, in particular the particle emissions of an internal combustion engine.

Advantageously, the use of the copolymer makes it possible to reduce both the fuel consumption and the pollutant emissions.

The copolymer described above may be used alone, in the form of a mixture of at least two of said copolymers or in the form of a concentrate.

The copolymer may be added to the liquid fuel in a refinery and/or may be incorporated downstream of the refinery and/or optionally as a mixture with other additives in the form of an additive concentrate, also known by the common name “additive package”.

The copolymer described above may be used as a mixture with an organic liquid in the form of a concentrate.

According to a particular embodiment, a concentrate for fuel comprises one or more copolymers as described above, as a mixture with an organic liquid.

The organic liquid is inert with respect to the copolymer described above and miscible in the liquid fuel described previously. The term “miscible” describes the fact that the copolymer and the organic liquid form a solution or a dispersion so as to facilitate the mixing of the copolymer in the liquid fuels according to the standard fuel supplementation processes.

For the purposes of the present invention, the term “miscible” means that the organic liquid and the liquid fuel form a solution when they are mixed, in all proportions, at room temperature.

The organic liquid is advantageously chosen from aromatic hydrocarbon-based solvents such as the solvent sold under the name Solvesso, alcohols, ethers and other oxygen-based compounds and paraffinic solvents such as hexane, pentane or isoparaffins, alone or as a mixture.

The concentrate may advantageously comprise from 5% to 99% by mass, preferably from 10% to 80% and more preferentially from 25% to 70% of copolymer(s) as described previously.

The concentrate may typically comprise from 1% to 95% by mass, preferably from 10% to 70% and more preferentially from 25% to 60% of organic liquid, the remainder corresponding to the copolymer defined previously, it being understood that the concentrate may comprise one or more copolymers as described above.

In general, the solubility of the copolymer in the organic liquids and the liquid fuels described previously will depend especially on the weight-average and number-average molar masses M_{w} and Mₙ, respectively, of the copolymer. The average molar masses M_{w} and Mₙ of the copolymer will be chosen so that the copolymer is soluble in the liquid fuel and/or the organic liquid of the concentrate for which it is intended.

The average molar masses M_{w} and Mₙ of the copolymer may also have an influence on the efficacy of this copolymer as a detergent additive. The average molar masses M_{w} and Mₙ will thus be chosen so as to optimize the effect of the copolymer, especially the detergent effect (engine cleanliness) in the liquid fuels described above.

Optimizing the average molar masses M_{w} and Mₙ may be performed via routine tests accessible to those skilled in the art.

According to a particular embodiment, the copolymer advantageously has a weight-average molar mass M_{w} ranging from 500 to 30 000 g.mol⁻¹, preferably from 1000 to 10 000 g.mo1⁻¹, more preferentially less than or equal to 4000 g.mol⁻¹, and/or a number-average molar mass (Mₙ) ranging from 500 to 15 000 g.mol⁻¹, preferably from 1000 to 10 000 g.mol⁻¹, more preferentially less than or equal to 4000 g.mol⁻¹. The number-average and weight-average molar masses are measured by size exclusion chromatography (SEC). The operating conditions of SEC, especially the choice of the solvent, will be chosen as a function of the chemical functions present in the copolymer.

According to a particular embodiment, the copolymer is used in the form of an additive concentrate in combination with at least one other fuel additive for an internal combustion engine other than the copolymer described previously.

The additive concentrate may typically comprise one or more other additives chosen from detergent additives other than the copolymer described above, for example from anticorrosion agents, dispersants, de-emulsifiers, antifoams, biocides, reodorants, proketane additives, friction modifiers, lubricant additives or oiliness additives, combustion promoters (catalytic combustion and soot promoters), agents for improving the cloud point, the flow point or the FLT (filterability limit temperature), anti-sedimentation agents, anti-wear agents and conductivity modifiers.

Among these additives, mention may be made in particular of:
a) proketane additives, especially (but not limitingly) chosen from alkyl nitrates, preferably 2-ethylhexyl nitrate, aryl peroxides, preferably benzyl peroxide, and alkyl peroxides, preferably tert-butyl peroxide;
b) antifoam additives, especially (but not limitingly) chosen from polysiloxanes, oxyalkylated polysiloxanes and fatty acid amides derived from plants or animal oils. Examples of such additives are given in EP 861 882, EP 663 000 and EP 736 950;
c) CFI (Cold Flow Improver) additives chosen from copolymers of ethylene and of unsaturated ester, such as ethylene/vinyl acetate (EVA), ethylene/vinyl propionate (EVP), ethylene/vinyl ethanoate (EVE), ethylene/methyl methacrylate (EMMA) and ethylene/alkyl fumarate copolymers described, for example, in U.S. Pat. No. 3,048,479, U.S. Pat. No. 3,627,838, U.S. Pat. No. 3,790,359, U.S. Pat. No. 3,961,961 and EP 261 957;

d) lubricant additives or anti-wear agents, especially (but not limitingly) chosen from the group constituted by fatty acids and ester or amide derivatives thereof, especially glyceryl monooleate, and monocyclic and polycyclic carboxylic acid derivatives. Examples of such additives are given in the following documents: EP 680 506, EP 860 494, WO 98/04656, EP 915 944, FR 2 772 783, FR 2 772 784;
e) cloud point additives, especially (but not limitingly) chosen from the group constituted by long-chain olefin/(meth)acrylic ester/maleimide terpolymers, and fumaric/maleic acid ester polymers. Examples of such additives are given in FR 2 528 051, FR 2 528 051, FR2 528 423, EP 112 195, EP 172 758, EP 271 385 and EP 291 367;
f) detergent additives, especially (but not limitingly) chosen from the group constituted by succinimides, polyetheramines and quaternary ammonium salts; for example those described in U.S. Pat. No. 4,171,959 and WO 2006/135 881;
g) cold workability polyfunctional additives chosen from the group constituted by polymers based on olefin and alkenyl nitrate as described in EP 573 490.

These other additives are generally added in an amount ranging from 100 ppm to 1000 ppm (each).

The mole ratio and/or mass ratio between monomer m_{b} and monomer mₐ and/or between block A and B or B₁ in the copolymer described above will be chosen so that the block copolymer is soluble in the fuel and/or the organic liquid of the concentrate for which it is intended. Similarly, this ratio may be optimized as a function of the fuel and/or of the organic liquid so as to obtain the best effect on the engine cleanliness.

Optimizing the mole ratio and/or mass ratio may be performed via routine tests accessible to those skilled in the art.

The mole ratio between monomer m_{b} and monomer mₐ or between blocks A and B or B₁ in the copolymer described above is advantageously from 1:10 to 10:1, preferably from 1:2 to 2:1 and more preferentially from 1:0.5 to 0.5:2.

According to a particular embodiment, a fuel composition is prepared according to any known process by supplementing the liquid fuel described previously with at least one copolymer as described above.

According to a particular embodiment, the fuel composition comprises:

(1) a fuel as described above, and

(2) one or more copolymers as described previously.

The fuel (1) is chosen in particular from hydrocarbon-based fuels and fuels that are not essentially hydrocarbon-based described previously, alone or as a mixture.

The combustion of this fuel composition comprising such a copolymer in an internal combustion engine produces an effect on the cleanliness of the engine when compared with the liquid fuel not specially supplemented and makes it possible in particular to prevent or reduce the fouling of the internal parts of said engine. The effect on the cleanliness of the engine is as described previously in the context of using the copolymer.

According to a particular embodiment, combustion of the fuel composition comprising such a copolymer in an internal combustion engine also makes it possible to reduce the fuel consumption and/or the pollutant emissions.

The copolymer (2) is preferably incorporated in small amount into the liquid fuel described previously, the amount of copolymer being sufficient to produce a detergent effect as described above and thus to improve the engine cleanliness.

The fuel composition advantageously comprises at least 10 ppm, preferably at least 50 ppm, more preferentially from 10 to 5000 ppm and in particular from 10 to 1000 ppm of copolymer(s) (2).

Besides the copolymer described above, the fuel composition may also comprise one or more other additives other than the copolymer according to the invention, chosen from the other known detergent additives, for example from anticorrosion agents, dispersants, de-emulsifiers, antifoams, biocides, reodorants, proketane additives, friction modifiers, lubricant additives or oiliness additives, combustion promoters (catalytic combustion and soot promoters), agents for improving the cloud point, the flow point or the FLT, anti-sedimentation agents, anti-wear agents and/or conductivity modifiers.

The various additives of the copolymer according to the invention are, for example, the fuel additives listed above.

According to a particular embodiment, a process for keeping clean (keep-clean) and/or for cleaning (clean-up) at least one of the internal parts of an internal combustion engine comprises at least the following steps:
the preparation of a fuel composition by supplementation of a fuel with one or more copolymers as described above, and
the combustion of said fuel composition in the internal combustion engine.

According to a particular embodiment, the internal combustion engine is a spark ignition engine, preferably with direct injection (DISI).

The internal part of the spark ignition engine that is kept clean and/or cleaned is preferably chosen from the engine intake system, in particular the intake valves (IVD), the combustion chamber (CCD or TCD) and the fuel injection system, in particular the injectors of an indirect injection system (PFI) or the injectors of a direct injection system (DISI).

According to another particular embodiment, the internal combustion engine is a diesel engine, preferably a direct-injection diesel engine, in particular a diesel engine with a common-rail injection system (CRDI).

The internal part of the diesel engine that is kept clean (keep-clean) and/or cleaned (clean-up) is preferably the injection system of the diesel engine, preferably an external part of an injector of said injection system, for example the fuel spray tip and/or one of the internal parts of an injector of said injection system, for example the surface of an injector needle.

The keep-clean and/or clean-up process advantageously comprises the successive steps of:

a) determination of the most suitable supplementation for the fuel, said supplementation corresponding to the selection of the copolymer(s) described above to be incorporated in combination, optionally, with other fuel additives as described previously and the determination of the degree of treatment necessary to achieve a given specification relative to the detergency of the fuel composition;

b) incorporation into the fuel of the selected copolymer(s) in the amount determined in step a) and, optionally, of the other fuel additives.

The copolymer(s) may be incorporated into the fuel, alone or as a mixture, successively or simultaneously.

Alternatively, the copolymer(s) may be used in the form of a concentrate or of an additive concentrate as described above.

Step a) is performed according to any known process and falls within the common practice in the field of fuel supplementation. This step involves defining at least one representative characteristic of the detergency properties of the fuel composition.

The representative characteristic of the detergency properties of the fuel will depend on the type of internal combustion engine, for example a diesel or gasoline engine, the direct or indirect injection system and the location in the engine of the deposits targeted for cleaning and/or maintaining the cleanliness.

For direct-injection diesel engines, the representative characteristic of the detergency properties of the fuel may correspond, for example, to the power loss due to the formation of deposits in the injectors or restriction of the fuel flow emitted by the injector during the functioning of said engine.

The representative characteristic of the detergency properties may also correspond to the appearance of lacquering-type deposits on the injector needle (IDID).

Other methods for evaluating the detergency properties of fuels have been widely described in the literature and fall within the general knowledge of a person skilled in the art. Nonlimiting examples that will be mentioned include the tests standardized or acknowledged by the profession or the following methods described in the literature:
For direct-injection diesel engines:
   the DW10 method, standardized engine test method CEC F-98-08, for measuring the power loss of direct-injection diesel engines
   the XUD9 method, standardized engine test method CEC F-23-1-01 Issue 5, for measuring the restriction of fuel flow emitted by the injector
   the method described by the Applicant in patent application WO2014/029 770, pages 17 to 20, for the evaluation of lacquering deposits (IDID), this method being cited by way of example and/or incorporated, by way of reference, to the present application.
For indirect injection gasoline engines:
   the Mercedes Benz M102E method, standardized test method CEC F-05-A-93, and
   the Mercedes Benz M111 method, standardized test method CEC F-20-A-98.
These methods make it possible to measure the intake valve deposits (IVD), the tests generally being performed on a Eurosuper gasoline corresponding to standard EN228.
For direct injection gasoline engines:
   the method described by the Applicant in the article “Evaluating Injector Fouling in Direct Injection Spark Ignition Engines”, Mathieu Arondel, Philippe China, Julien Gueit; Conventional and future energy for automobiles; 10th international colloquium; Jan. 20-22, 2015 [in Stuttgart/Ostfildern; proceedings 2015]; International Colloquium Fuels/Technische Akademie Esslingen by Techn. Akad. Esslingen, Ostfildern; 2015 (ISBN 9783943563160), for evaluation of the coking deposits on the injector, this method being cited by way of example and/or incorporated, by way of reference, to the present application;
   the method described in US 2013/0 104 826, for evaluation of the coking deposits on the injector, this method being cited by way of example and/or incorporated, by way of reference, to the present application and/or incorporated, by way of reference, to the present application.

The determination of the amount of copolymer to be added to the fuel composition to achieve the specification will typically be performed by comparison with the fuel composition not containing the copolymer according to the invention.

The amount of copolymer may also vary as a function of the nature and origin of the fuel, in particular as a function of the content of compounds bearing n-alkyl, isoalkyl or n-alkenyl substituents. Thus, the nature and origin of the fuel may also be a factor to be taken into consideration for step a).

The process for maintaining the cleanliness (keep-clean) and/or for cleaning (clean-up) may also comprise an additional step after step b) of checking the target reached and/or of adjusting the amount of supplementation with the copolymer(s) as detergent additive.

The copolymers according to the invention have noteworthy properties as detergent additive in a liquid fuel, in particular in a gas oil or gasoline fuel, in particular block copolymers.

The copolymers according to the invention, in particular the block copolymers according to the invention, are particularly noteworthy especially since they are efficient as detergent additive for a wide range of liquid fuels and/or for one or more types of engine specification and/or against one or more types of deposit which become formed in the internal parts of internal combustion engines.

1. A method for keeping clean and/or for cleaning at least one of the internal parts of an internal combustion engine, said method comprising the introduction in said internal combustion engine of at least one copolymer comprising at least one repeating unit comprising an alkyl ester or alkylester function and one repeating unit comprising a nitrile group.

2. The method as claimed in claim 1, wherein the copolymer is a block copolymer comprising at least:
one block A consisting of a chain of structural units derived from an alkyl (meth)acrylate monomer (mₐ), and
one block B consisting of a chain of structural units derived from an olefinic monomer (m_{b}) comprising a nitrile group.

3. The method as claimed in claim 2, wherein the block copolymer is obtained by block polymerization, optionally followed by one or more post-functionalizations.

4. The method as claimed in claim 1, wherein the copolymer is obtained by copolymerization of at least:
one alkyl (meth)acrylate monomer (mₐ), and
one olefinic monomer (m_{b}) comprising a nitrile group.

5. The method as claimed in claim 2, wherein the alkyl (meth)acrylate monomer (mₐ) is chosen from C₁ to C₃₄ alkyl (meth)acrylates.

6. The method as claimed in claim 2, wherein the monomer (m_{b}), comprising at least one nitrile group, corresponds to formula (I) below: 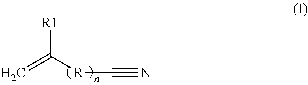
wherein:
n represents an integer chosen from 0 and 1,
R represents a hydrocarbon-based chain comprising from 1 to 24 carbon atoms, optionally comprising one or more substituents chosen from: OH, NH2, CN and/or optionally comprising one or more groups chosen from: an ether bridge —O—, an amine bridge —NH—, an imine bridge —N═, an ester bridge —COO—, a ketone bridge —CO—, an amide bridge —CONH—, a urea bridge —NH—CO—NH—, a carbamate bridge —O—CO—NH—.
R₁ represents H or CH3.

7. The method as claimed in claim 6, wherein monomer (m_{b}) is chosen from acrylonitrile, methacrylonitrile, cyanostyrene and cyano-alpha-methylstyrene.

8. The method as claimed in claim 7, wherein the copolymer is a block copolymer comprising at least:
one block A consisting of a chain of structural units derived from the alkyl (meth)acrylate monomer (mₐ), and
one block B₁ consisting of a chain of structural units derived from acrylonitrile (m_{b}), methacrylonitrile, cyanostyrene or cyano-alpha-methylstyrene.

9. The method as claimed in claim 1, comprising before the introduction of the liquid fuel in the internal combustion engine:
1) the preparation of a concentrate for fuel comprising one or more copolymers as described in claim 1, as a mixture with an organic liquid, said organic liquid being inert with respect to the copolymer(s) and miscible with said fuel, and
2) the introduction of said concentrate for fuel in the liquid fuel.

10. The method as claimed in claim 1, comprising, before the introduction of the liquid fuel in the internal combustion engine, the addition to the liquid fuel of
one or more copolymers as described in claim 1.

11. The method as claimed in claim 10, wherein the fuel composition comprises at least 5 ppm of at least one copolymer comprising at least one repeating unit comprising an alkyl ester or alkylester function and one repeating unit comprising a nitrile group.

12. The method as claimed in claim 10, wherein the fuel is chosen from hydrocarbon-based fuels and fuels that are not essentially hydrocarbon-based, alone or as a mixture.

13. (canceled)

14. The method as claimed in claim 1, wherein the copolymer is added to the liquid fuel to prevent and/or reduce the formation of deposits in at least one of the internal parts of said engine and/or to reduce the existing deposits in at least one of the internal parts of said engine.

15. The method as claimed in claim 1, for reducing the fuel consumption of an internal combustion engine.

16. The method as claimed in claim 1, for limiting and/or reducing and/or avoiding and/or preventing the pollutant emissions of an internal combustion engine.

17. The method as claimed in claim 1, wherein the internal combustion engine is a spark ignition engine.

18. The method as claimed in claim 17, for limiting and/or reducing and/or preventing the formation of deposits in at least one internal part of a spark ignition engine chosen from the engine intake system, the combustion chamber, the fuel injection system.

19. The method as claimed in claim 1, wherein the internal combustion engine is a diesel engine.

20. The method as claimed in claim 19, for limiting and/or reducing and/or avoiding and/or preventing the formation of deposits in the injection system of the diesel engine, and/or on an internal part of an injector of said injection system.

21. The method as claimed in claim 20, for limiting and/or reducing and/or avoiding and/or preventing:
the formation of deposits associated with coking and/or deposits of soap or lacquering type, and/or
power loss due to the formation of said deposits in the internal parts of a direct-injection diesel engine, said power loss being determined according to the standardized engine test method CEC F-98-08, and/or
restriction of the fuel flow emitted by the injector of a direct-injection diesel engine during its functioning, said flow restriction being determined according to the standardized engine test method CEC F-23-1-01.

22-23. (canceled)
